(19) United States
(12) Patent Application Publication
(10) Pub. No.: US 2010/0229800 A1
(43) Pub. Date: Sep. 16, 2010

(54) BIRD FORAGING APPARATUS

(76) Inventor: Emily LEVINE, Montclair, NJ (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/704,652

(22) Filed: Feb. 12, 2010

Related U.S. Application Data
(60) Provisional application No. 61/152,041, filed on Feb. 12, 2009.

(51) Int. Cl. A01K 39/01

(52) U.S. Cl. 119/57.8; 119/51.01; 119/62

(57) ABSTRACT

An apparatus for allowing animals, including birds, to forage food from a foraging holes disposed on said platform. Preferably the holes are covered with a frangible sheet that has to be broken by the animal or bird to access the food in the foraging holes. The sheet is made of a material that hides the content of the holes.

### RELATED APPLICATIONS

This application claims priority to U.S. Provisional Application Ser. No. 61/152,041 filed on Feb. 12, 2009 and incorporated herein by reference in its entirety.

### FIELD OF THE INVENTION

The present invention relates generally to a feeding apparatus that mimics a natural foraging environment for a bird during the course of feeding. More particularly, the present invention relates to an improved bird feeder that includes a plurality of foraging holes that store bird food, wherein a rupture or frangible sheet is used to cover the plurality of foraging holes in order to encourage the bird to work to gain access to the food. Working for food mimics the birds' natural feeding behaviors commonly seen in the wild, including pecking and searching for food.

### BACKGROUND OF THE INVENTION

It is well known that many bird owners confine their pet birds in a birdcage. By confining their pet birds in a cage, the owners are able to observe their intrinsic beauty, such as their shape and color of their feathers.

However, this design has many deficiencies. One deficiency is that it suppresses the pet bird's natural feeding behaviors. By providing a dispenser that makes food readily available, such as a feeding bowl, the pet bird does not need to forage for food, and therefore, neglects to display any natural feeding behaviors that are inherent in their natural characteristics. It has been documented that confined birds benefit physically and psychologically from working for their food. Natural foraging behavior is stimulating.

Another deficient aspect of this food bowl design is directed towards a specific type of bird that normally does not eat where it sleeps, such as a parrot. Although the owner can remove the pet parrot from its birdcage, this also deters the parrot from learning any natural feeding behaviors since the food is easily accessible.

In this particular instance, the conventional bird feeder is accessible to all pet birds housed in the birdcage. As such, the opening of the food bowl must be large enough to feed each type of bird.

Thus, there exists a need for an invention that provides a bird foraging apparatus to cure the deficiencies of today's bird feeders.

### SUMMARY OF THE INVENTION

Accordingly, in view of the deficiencies of the prior art discussed above and other deficiencies not specifically referenced, it is a primary object of the present invention to provide an improved bird foraging apparatus that stimulates pet birds to perform natural feeding behaviors commonly seen in the wild.

Another objective is to mimic the natural behavior of wild birds, allowing them to eat in a different location than where they sleep.

The present invention provides an improved bird foraging apparatus with a plurality of foraging holes constructed on a horizontal base. The foraging holes vary in size allowing pet birds to work using their feet and beaks in different angles and ways to obtain the food.

The improved bird foraging apparatus includes a lid with a plurality of openings. In one embodiment, each opening constructed on the lid aligns with an associated foraging hole of the horizontal base. Preferably, a resilient material made of a transparent or opaque material covers the foraging holes in the base. This resilient material creates an obstacle for the pet bird during foraging, thereby making the bird work for the food, which is a more natural feeding behavior commonly displayed in the wild. In one embodiment, the resilient material is positioned so that it covers the holes completely rendering them invisible to the birds. Accordingly, the birds have to peck on the board and search for the holes with the food just like in a natural environment.

In one embodiment, a vertical post fixed securely to the lid. The vertical post also includes a plurality of additional foraging holes for storing bird food.

In one embodiment the improved bird foraging apparatus that includes a horizontal arm. One side of the horizontal arm is attached to the vertical post. The horizontal arm includes a plurality of hooks for hanging different types of food to stimulate the pet bird to display natural feeding behaviors common in the wild.

In another embodiment, the platform with the foraging holes is affixed to a post or other support in a vertical orientation, i.e., with its major surface with the foraging holes being disposed vertically. Horizontal bars are then attached to the vertical surface to provide perches to the birds as they peck through the membrane into the holes.

### BRIEF DESCRIPTION OF THE DRAWINGS

With reference to the attached drawings:

FIG. 1 is a perspective view of a preferred embodiment of the assembled bird feeder apparatus of the present invention;

FIG. 2 is a perspective view of the lid removed from the horizontal base;

FIG. 3 is a perspective view of a foraging hole of the horizontal base;

FIG. 4 is a perspective view of the lid being selectively closed on top of the horizontal base;

FIG. 5 is a perspective view of the vertical post, wherein the bottom of the vertical post is fixedly secured to the lid;

FIG. 6 is a perspective view of a horizontal arm with hooks, wherein one side of the horizontal arm is fixedly secured to the vertical post;

FIG. 7 shows a plan view of the top of the base with several foraging holes of different sizes and a pen to show the relative sizes of the foraging holes;

FIG. 8 shows a perspective view of a sheet of frangible material used to cover the foraging holes;

FIG. 9 shows a perspective view of a role of frangible material used in the invention;

FIG. 10 shows a perspective view of an alternate embodiment in which hooks are replaced by D-rings in the horizontal member;

FIG. 11 shows a perspective view of another alternate embodiment similar to the one in FIG. 10; and

FIG. 12 shows an elevational view of yet another embodiment in which the platform is positioned so that the surface with the foraging holes is disposed in a vertical plane.

### DETAILED DESCRIPTION OF THE PREFERRED EMBODIMENT

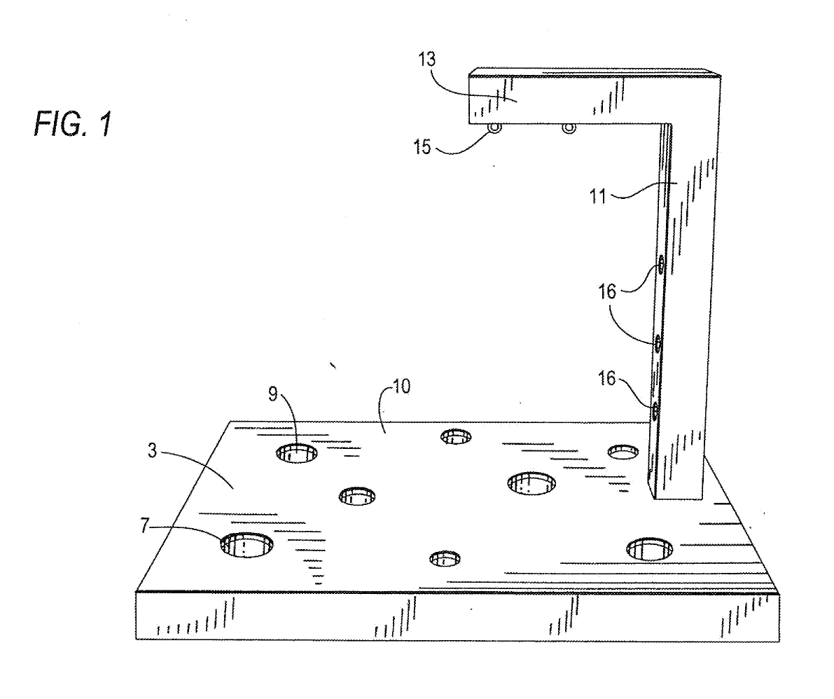

A detailed description will now be provided of the preferred embodiment, as well as various additional embodiments. FIG. 1 illustrates an improved foraging apparatus (1). The apparatus is formed of a platform 10 including a lid (3) is placed on top of a horizontal base (5) (not shown in FIG. 1). The lid (3) is constructed with a plurality of openings (7) that allows access to an associated foraging hole (9) constructed on the horizontal base (5). The primary purpose of these foraging holes (9) is to store bird food.

The foraging apparatus (1) further includes a vertical post (11) that is fixedly secured to the platform (10) in a conventional manner. The vertical post (11) is also constructed with a plurality of vertical post foraging holes (12) for storing food. Similar to the foraging holes (9), the vertical post foraging holes (12) is also constructed to store bird food.

Additionally, one side of the vertical post (11) is attached to a horizontal arm (13) that extends over the base. The horizontal arm (13) includes a plurality of fastening means (15) for securing bird food to the vertical post (11).

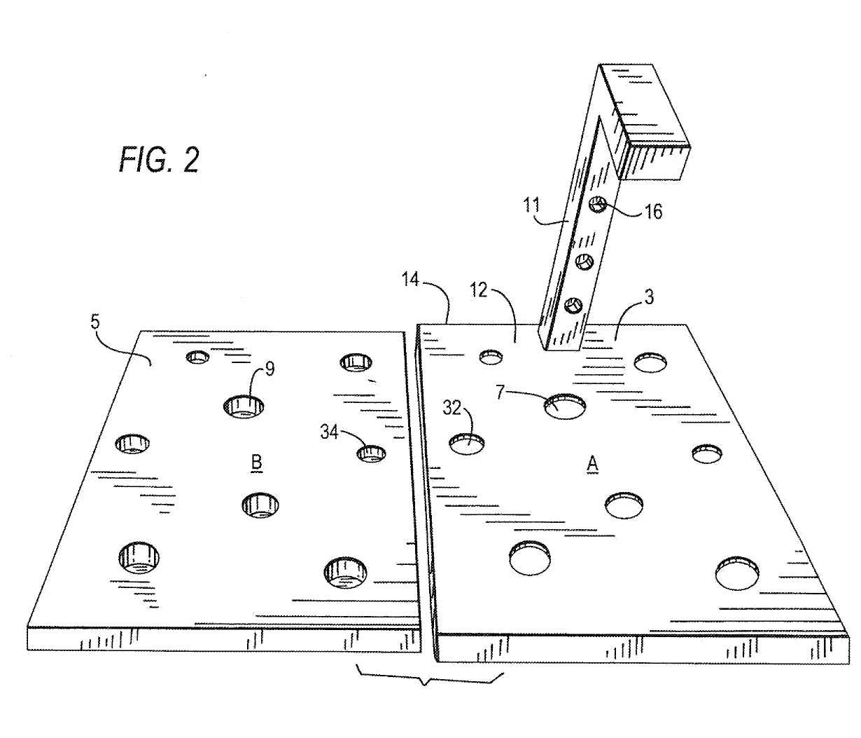

A more detailed description of the present invention will now be described, with reference being made to FIG. 2.

FIG. 2 illustrates the two parts of the platform 10, e.g., horizontal base (5) and lid 3 described above. The horizontal base (5) includes the plurality of foraging holes (9), in which these holes are adapted to store bird food, such as seeds and the like. These foraging holes (9) of the horizontal base (5) can vary in size to accommodate various types of pet birds with different beak sizes. Additionally, these foraging holes varying in different sizes forces the bird to manipulate his beak and foot differently to get to the food. As such, the bird has to think differently by altering how he obtains food with different size openings. The depth of holes 9 can also vary.

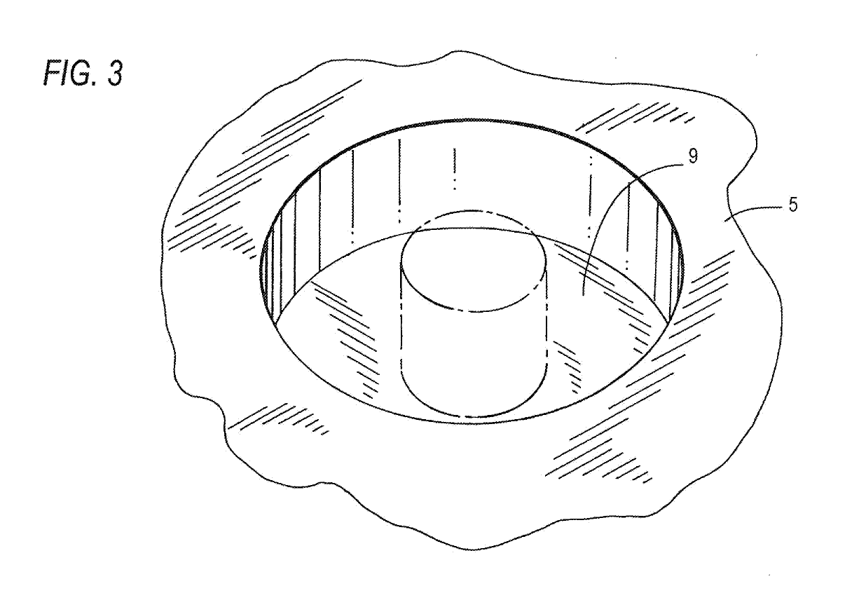

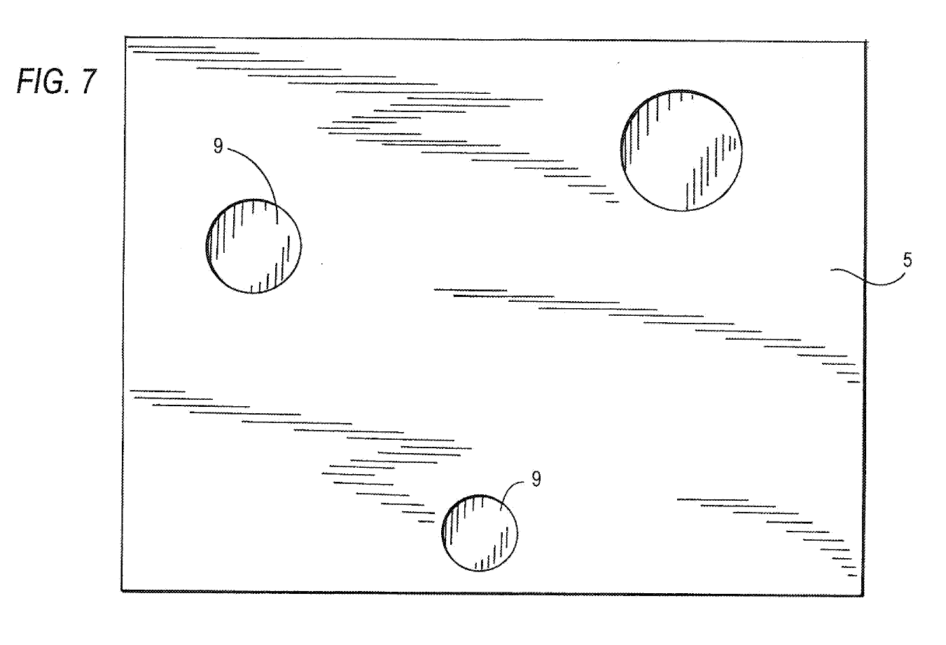

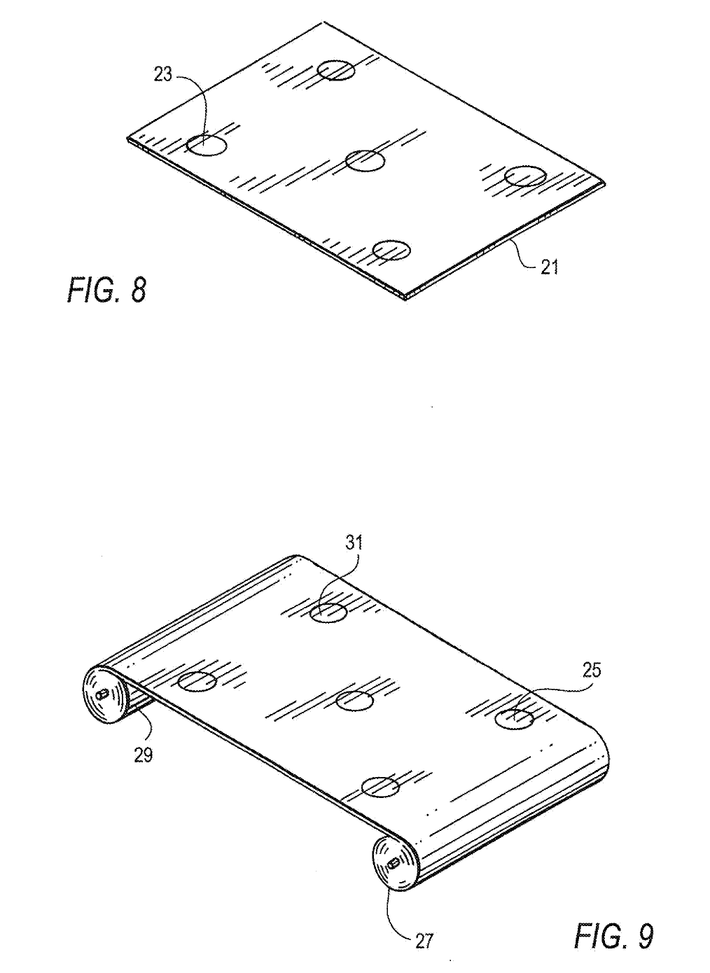

One type of the foraging holes (9) is illustrated in FIG. 3. FIG. 3 illustrates a foraging hole (9) having a depth and diameter that is approximately greater than an inch. However, the foraging holes (9) of the present invention are not limited to the previously described depth and width, but rather, it is contemplated by the inventors that the foraging holes (9) could be smaller or larger as illustrated in FIG. 7.

An example of the benefit of having varying foraging holes is when a bird-owner has two or more pet birds, and each pet bird vary in size. The different sized holes are intended to provide complexity, variation, and mental stimulation.

As further illustrated in FIG. 2, the horizontal base (5) is square or rectangular shaped. However, the present invention is not limited to a four sided shape as illustrated in FIG. 2. Instead, the inventors of the present invention have also contemplated shapes that have less than or greater than four sides.

For example, the horizontal base (5) could be shaped as a triangle, octagon or a design pattern that resembles an animal. As such, the horizontal base (5) of the present invention is not limited to a rectangular shape as shown and described.

FIG. 2 shows a bottom view of the lid (3). The lid (3) is constructed to be slightly larger than the horizontal base (5) the lid (3) includes a flat portion (12) with the holes (7) and a plurality of peripheral walls (14) surrounding the flat portion (12). The height of the walls (14) is selected so that it is preferably the same as the height of base (5). The walls (14) and the flat portion (12) cooperate to form lid (3) so that the lid fits over base (5) snuggly.

Openings (7) are sized and shaped so that when the lid (3) is placed on base (5) they form windows into the foraging holes (9). As such, each opening (7) of the lid (3) corresponds to the shape and size of an associated foraging hole (9) constructed on the horizontal base (5).

In order to encourage the bird to work for the food, a resilient material (not shown in FIG. 2) is used to cover either each opening (7) of the lid (3) or each hole (9). This resilient material could be in the form of paper, cloth, or other well known material that provides sufficient resistance so that the bird has to peck through the material and break through it to get to the food within respective hole (9). In one embodiment, the resilient material can either be securely fastened to the top side of the horizontal base (5) or the bottom side of the lid (3), thereby covering the foraging holes (9). In other words, the resilient material is entrapped between the lid (3) and the base (5) As such, a pet bird is encouraged to perform natural feeding behaviors by continuously pecking the resilient material in order to obtain the food residing in the foraging holes (9).

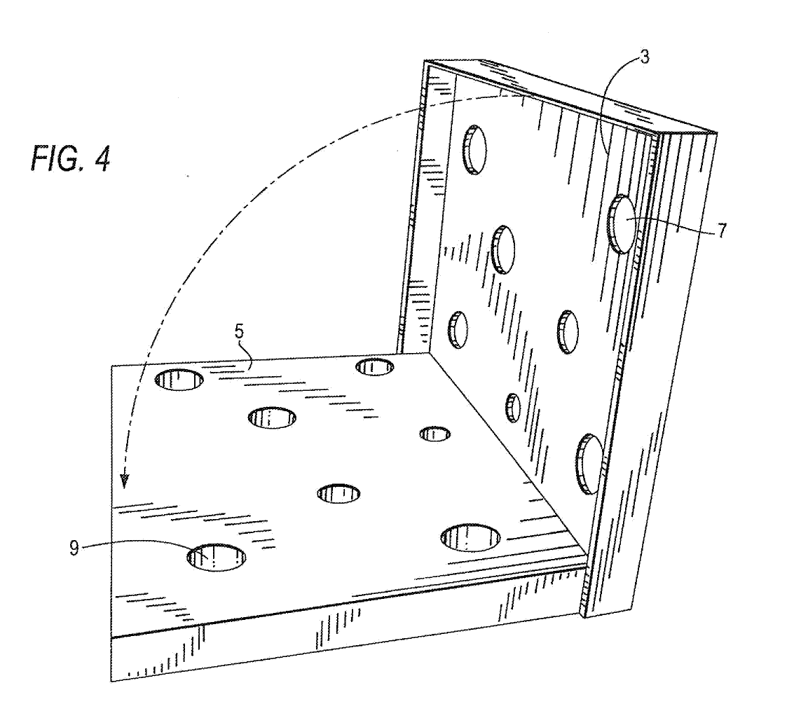

As discussed above, since the lid (3) is slightly larger than the horizontal base (5), FIG. 4 illustrates the method of closing the lid (3) on top of the horizontal base (5). By allowing the owner of the foraging apparatus (1) to selectively remove the lid (3) from the horizontal base (5), the owner is able to replace the resilient material covering the foraging holes (9) and to replenish the foraging holes (9) with bird food.

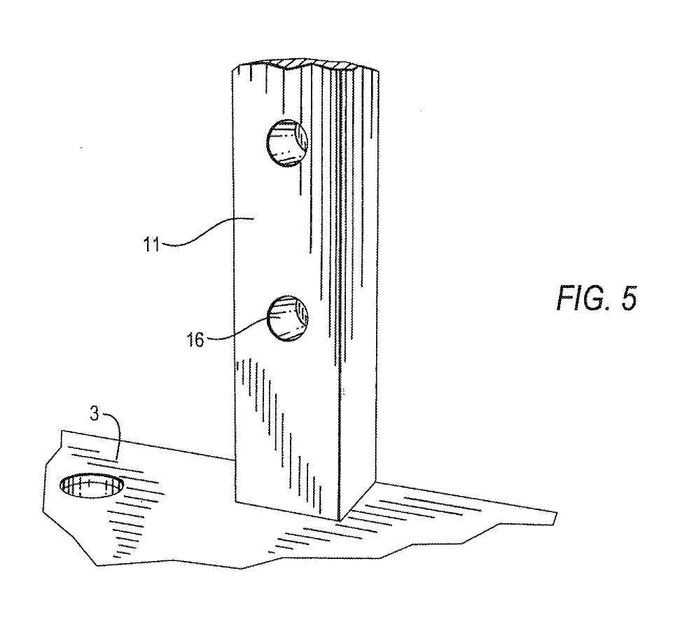

In one embodiment of the invention, the lid (3) and base (5) are formed with a respective round apertures (32), (34). The post (11) terminates at its lower end with a rod (not shown) sized and shaped to form an interference fit with the openings (32), (34). Therefore, once the lid (3) is closed over the base (5), the post (11) is installed on top of the lid (3) by inserting its rod into the openings (320, (34) so that the post (11) is firmly seated on platform (10). As shown in FIG. 5. The present invention is not limited to the above discussed securing means. Instead, other securing means well known in the relevant art can be used to secure the vertical post (11) to the lid (3). For example, the securing means could be a screw and bolt configuration. Alternatively, the securing means could be a strong adhesive.

Additionally, as FIG. 5 illustrates the vertical post (11) has a plurality of vertical post foraging holes (16). Similar to the foraging holes (9) of the horizontal base (5), these vertical post foraging holes (16) are used to store bird food and can vary in different shapes and sizes.

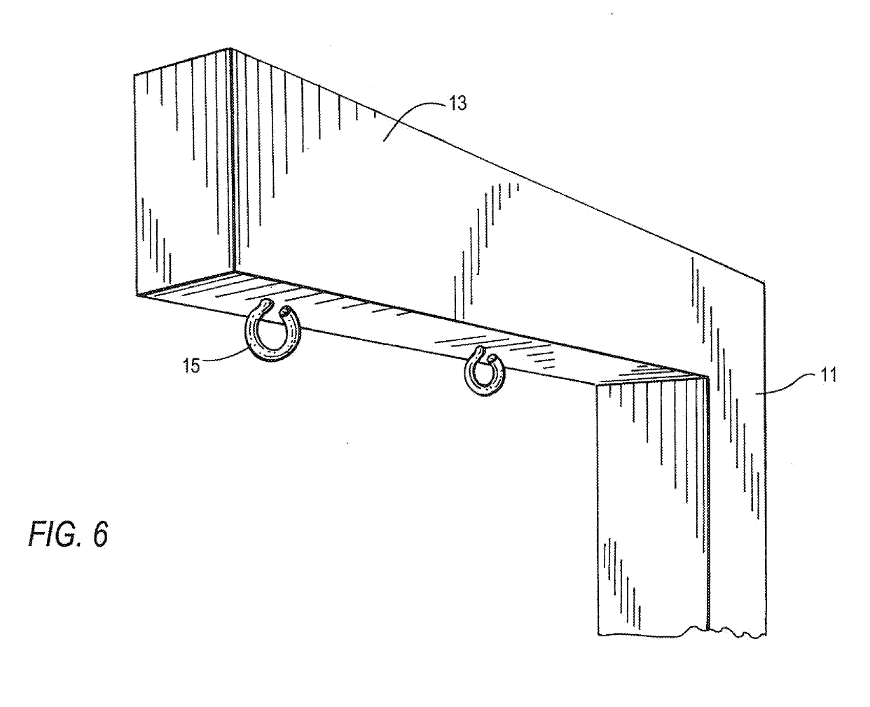

Once the vertical post (11) is securely fastened to the horizontal base (5) and the lid (3), a horizontal arm (13) is securely attached to the other side of the vertical post (11) as illustrated in FIG. 6. The attachment means of the horizontal arm (13), relative to the vertical post (11) can be secured in any other conventional manner. Preferably, the arm (13) is permanently attached to the post (11) so that the two elements need not be assembled or secured to each other every time the lid (3) is removed and reinstalled on base (5).

FIG. 6 further illustrates fastening means such as hooks (15) that are used to fasten other types of bird food to the foraging apparatus (1). Other types of bird food include, but are not limited to, fruits, bread, etc.

As illustrated in FIG. 9, the frangible material could be provided as a sheet of paper (21) that can be inserted between the lid (3) and base (5). The sheet of paper can be plain, unmarked or can be provided with indicia as at (23) to provide some means for the bird to find the holes (9). In one alternate embodiment of the invention, the sheet (21) can be attached to the top of the lid (3) using an adhesive or other conventional means. The sheet (21) can be replaced by a new sheet as necessary. Alternatively, the new sheet can be placed on top of an old sheet.

In another embodiment, the instead of a sheet the frangible material can be provided in form of a roll 25 that can be opened as shown so that it can be extended over the holes (7) or (9). The two ends (27), (29) can be attached to the platform 10 by conventional means and indicia may be printed on the roll as at (31).

The method of a preferred embodiment of assembling the foraging apparatus will now be described. The owner of the foraging apparatus (1) first places the horizontal base (5) on a surface. Once the horizontal base (5) is placed on the surface, the owner can either fasten the resilient material to the top side of horizontal base (5), the bottom side of the lid (3), or top of lid (3) by fastening means that are well known in the art. The lid (3) is then placed on top of the horizontal base (5), keeping in mind that the openings (7) on the lid (3) must align with the foraging holes (9) and the upstanding beams (17) of the horizontal base (5). The vertical post (11) is thereafter attached on top of the lid (3) if necessary. Similarly, the horizontal arm (13) is attached to the other side of the vertical post (11) if necessary.

Preferably, the resilient material is made from materials having varying thickness and durability. It is intended that the bird be initially introduced to the apparatus without any paper barrier, so that the food is visible. Once familiar with the apparatus, a thin sheet of opaque paper can be used as the resilient material, but the bird will quickly be able to peck through it to obtain the food. In time, paper barriers of increased thickness are used so that the bird needs to work harder to obtain the food. In addition, or alternatively, the barrier thickness and/or durability and strength can be changed from one hole to the other.

In another embodiment, a new lid can be utilized that has various obstacles at different holes in the base. For instance, instead of a hole in the lid, there is a leather tie that the bird has to untie, in order to gain access to the hole and food below. Other obstacles or barriers can be provided as well.

In yet another embodiment, small cups are provided that fit snugly in the holes. These cups hold the food, and can be removed and machine washed periodically.

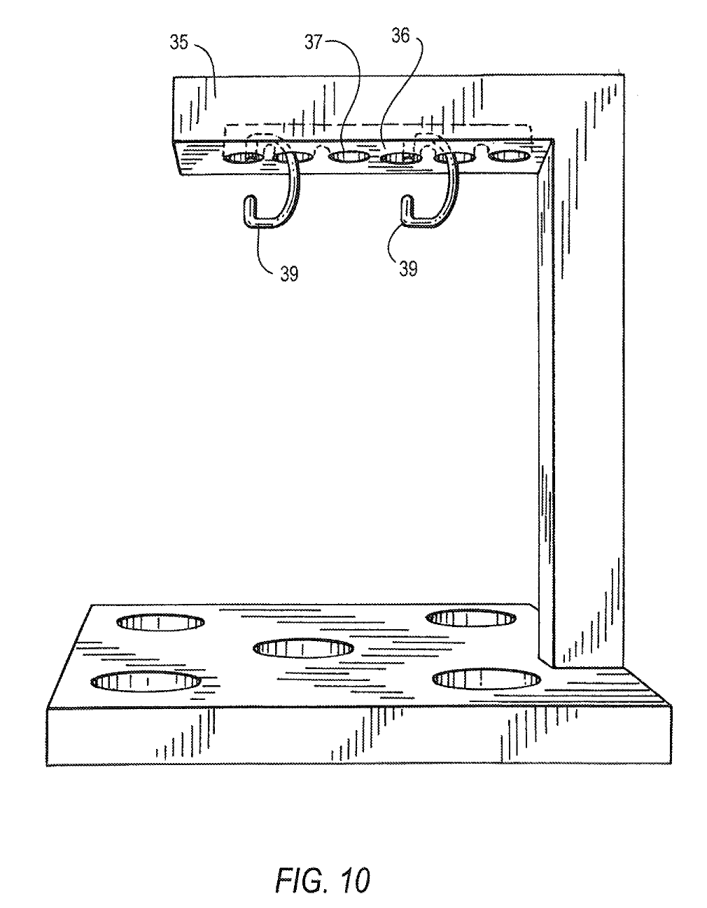

In an alternate embodiment shown in FIG. 10 a horizontal member 35 is provided that is hollow and is provided on its lower surface 36 with a plurality of circular or oval holes 37. These holes can receive one or more conventional D-shaped rings 39. The rings 39 can be opened and are used to hang various food or other items for the birds. Of course rings 39 can also be circular, oval or have any other shape.

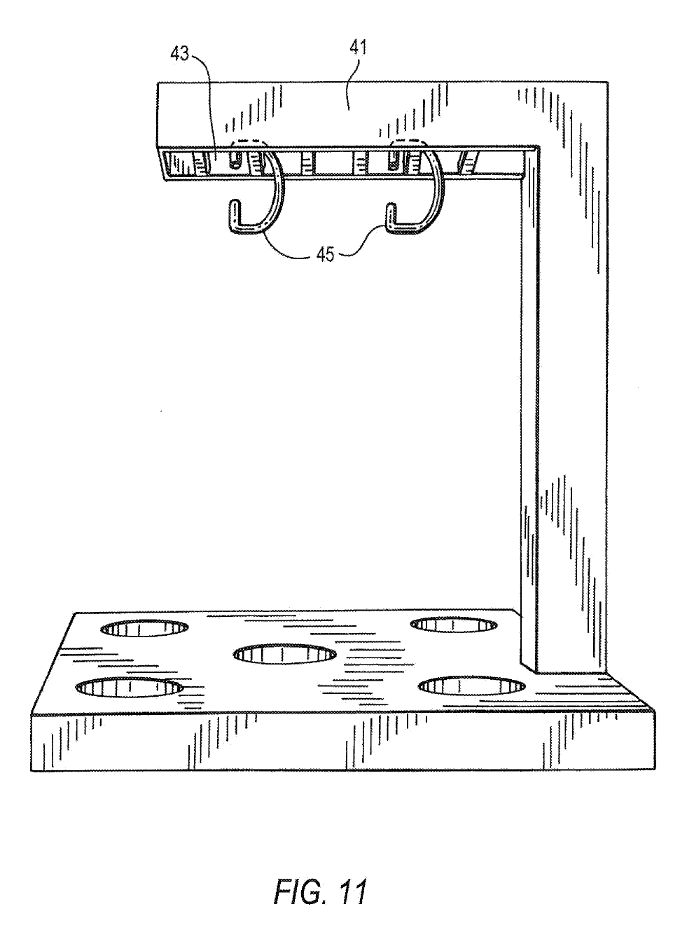

In the alternate embodiment of FIG. 11 a similar arrangement is presented to the one in FIG. 10 except that instead of holes, horizontal member 41 is provided with square or rectangular holes 43 that receive the D-shaped ring 45.

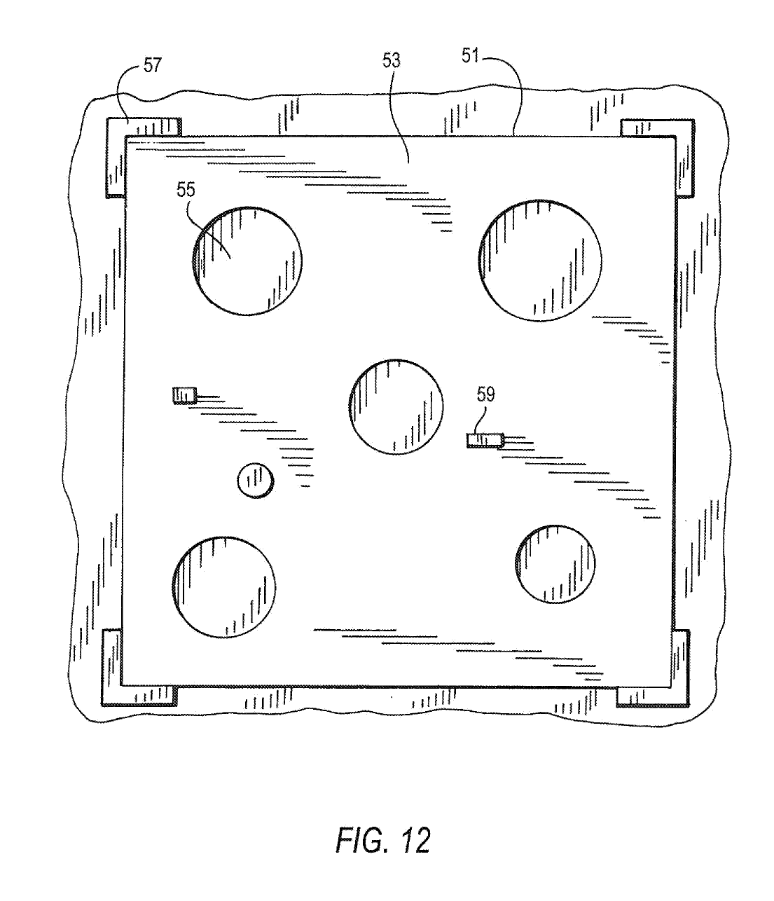

In the preferred embodiment described so far the platform 10 is arranged so that its top surface with the holes 7, 9 are horizontal. In an alternate embodiment shown in FIG. 12, a platform 51 is presented with a surface 53 having holes 55. The holes 55 are used to store bird food or other matter and are optionally covered by a translucent or opaque frangible membrane (not shown) so that the birds have to peck through to find the food. The platform 51 is attached to an upright support (not shown) by conventional brackets 57. IN this embodiment, several horizontal bars 59 are also provided that extend out of the vertical surface 53. These bars 59 may have circular or rectangular cross-sections and are sized and shaped so that they can be used as perches by the birds during feeding.

Numerous modifications may be made to the invention without departing from its scope as defined in the appended claims.

I claim:

1. An apparatus for feeding animals comprising:
a platform formed of a base with a top surface, said top surface being formed with a plurality of holes sized and shaped to hold food; and
a lid sized and shaped to fit over said base and having apertures matching the positions of said holes for providing access thereto.

2. The apparatus of claim 1 further comprising an upright post attached to said platform, said upright post having additional holes for holding food.

3. The apparatus of claim 2 further comprising a horizontal bar attached to said post and having attachment members for holding food stuff.

4. The apparatus of claim 1 further comprising a frangible member extending continuously across at least some of said holes of said base.

5. The apparatus of claim 1 wherein said frangible member is a sheet extending across said base provided to hide the content of the foraging holes.

6. The apparatus of claim 5 wherein said sheet disposed between said base and said lid.

7. The apparatus of claim 5 wherein said sheet is attached to said base.

8. The apparatus of claim 5 wherein said sheet is attached to said lid.

9. The apparatus of claim 8 wherein said lid has a top and a bottom surface and said sheet is attached to said bottom surface.

10. The apparatus of claim 8 wherein said lid has a top and a bottom surface and said sheet is attached to said top surface.

11. An apparatus for allowing a bird for foraging for its food comprising:
a platform having a top surface formed with a plurality of foraging holes holding bird food; and a frangible sheet covering at least some of said foraging holes continuously so that a foraging bird has to break the sheet to access the foraging holes, said sheet being made of a material through which a bird cannot see the foraging holes or what is in them.

12. The apparatus of claim 11 wherein said platform is formed of a base and a lid disposed on top of the base.

13. The apparatus of claim 12 wherein said sheet is disposed between said base and said lid.

14. The apparatus of claim 11 wherein said sheet is replaceable.

15. The apparatus of claim 11 further comprising a vertical post with additional foraging holes.

16. The apparatus of claim 15 further comprising a horizontal bar attached to said post and extending on top of the platform.

17. The apparatus of claim 15 further comprising a vertical post attached to the platform and a horizontal bar extending over the platform and attached to the vertical post.

18. The apparatus of claim 15 wherein said horizontal bar includes attachment members extending downwardly toward the platform for hanging objects.

19. A bird feeding apparatus comprising:
a platform arranged and constructed for attachment to a vertical support, said platform having a vertical surface formed with a plurality of foraging holes for storing food, and a frangible sheet covering said foraging holes.

20. The apparatus of claim 19 further comprising bars attached to platform and sized and shaped to act as perches for the birds.
